(19) United States
(12) Patent Application Publication
(10) Pub. No.: US 2024/0336117 A1
(43) Pub. Date: Oct. 10, 2024

(54) COOLING SYSTEM FOR ELECTRICALLY DRIVEN TRACTOR

(71) Applicant: LS MTRON LTD., Anyang-si (KR)

(72) Inventors: Dongsu LEE, Anyang-si (KR); Jaiyoon SHIN, Anyang-si (KR); Hanyeol YU, Anyang-si (KR); Junguk LEE, Anyang-si (KR); Hanjoon CHO, Anyang-si (KR)

(21) Appl. No.: 18/611,215

(22) Filed: Mar. 20, 2024

(30) Foreign Application Priority Data
Apr. 4, 2023 (KR) 10-2023-0043897

(51) Int. Cl. B60H 1/32; B60H 1/00

(52) U.S. Cl. CPC B60H 1/3228; B60H 1/00392

(57) ABSTRACT

Disclosed herein is a cooling system for an electric-powered tractor. The cooling system includes: a refrigerant circuit configured to circulate a refrigerant while repeating a process in which compression and condensation is performed and then expansion and evaporation is performed; a condensation fan configured to supply air; a coolant circuit configured to circulate a coolant and cool a battery with the cold of the coolant; a branch circuit configured to branch off from the refrigerant circuit at a second point and then merge with the refrigerant circuit at a first point, and configured such that the expansion and evaporation of the refrigerant is performed therein; an evaporation fan configured to supply air to be cooled and also supply cooled air to an area where a driver is located; and a distributor configured to distribute a part of the refrigerant to the branch circuit.

### CROSS-REFERENCE TO RELATED APPLICATION

This application claims the benefit of Korean Patent Application No. 10-2023-0043897 filed on Apr. 4, 2023, which is hereby incorporated by reference herein in its entirety.

### FIELD

The present disclosure relates to a tractor that is a work vehicle used in agricultural work, and particularly to a cooling system for an electric-powered tractor.

### BACKGROUND

Tractors are work vehicles that perform various types of agricultural work with a plurality of auxiliary implements attached thereto and detached therefrom.

There are various types of tractors ranging from a small-sized tractor with low horsepower to a large-sized tractor with considerably high horsepower.

Many types of tractors have cabins in which a driving room is isolated from an outside environment so that a driver can perform work in a comfortable environment. Additionally, these tractors are each equipped with a system for the air conditioning (cooling, heating, air purification, etc.) of the driving room in the cabin.

However, many types of small tractors of 40 horsepower or less, which are used for simple work (garden maintenance or small-scale rice field work for considerably small work areas), are not equipped with cabins. Accordingly, the driving rooms thereof are open to the outside, and there is no practical benefit in installing an air conditioning system. As a result, the drivers of small tractors usually perform work while exposed to outside environments. For this reason, in winter, drivers need to wear thick winter clothing and perform work. However, in hot summer, there is no suitable means to remove heat from drivers.

However, installing a cabin and a cooling system in a small-sized tractor reduces the marketability of a product because an increase in the effectiveness thereof is lower than an increase in manufacturing costs.

Meanwhile, in recent years, interest in energy efficiency and environmental issues has been growing around the world. In response to this, diesel tractors are being avoided, and research and development is being actively conducted on tractors that do not emit carbon dioxide and fine dust, such as electric-, hydrogen-, and biofuel-powered tractors. In particular, in the case of electric-powered tractors, small-sized tractors have been chiefly commercialized.

Cabin-type electric-powered tractors are also equipped with a cooling system for a driver. However, small electric-powered tractors without a cabin are not equipped with a separate cooling system for a driver. Therefore, drivers working in hot environments are bound to have adverse effects in terms of safety and work efficiency.

### SUMMARY

The present disclosure has been conceived from the following motives:

First, there is a need to contemplate a new type of cooling technology that can be applied to electric-powered tractors.

Second, there is a need to contemplate cooling technology that can be especially applied to small electric-powered tractors without a cabin.

According to a first aspect of the present disclosure, there is provided a cooling system for an electric-powered tractor, the cooling system including: a refrigerant circuit configured to circulate a refrigerant while repeating a process in which compression and condensation is performed while the refrigerant moves from a first point to a second point and then expansion and evaporation is performed while the refrigerant moves from the second point to the first point; a condensation fan configured to supply air required for the condensation of the refrigerant performed in the refrigerant circuit; a coolant circuit configured to circulate a coolant cooled through heat exchange with the refrigerant evaporated in the refrigerant circuit, and to cool a battery with the cold of the coolant; a branch circuit configured to branch off from the refrigerant circuit at the second point and then merge with the refrigerant circuit at the first point, and configured such that the expansion and evaporation of the refrigerant is performed therein; an evaporation fan configured to supply air to be cooled by the evaporation of the refrigerant performed in the branch circuit, and to supply the air, cooled by the branch circuit, to an area where a driver is located; and a distributor disposed at the second point, and configured to distribute a part of the refrigerant, circulating in the refrigerant circuit, to the branch circuit; wherein the refrigerant distributed from the refrigerant circuit to the branch circuit at the second point is input to the refrigerant circuit at the first point after expansion and evaporation.

The cooling system may further include a controller configured to control the distributor so that the amount of refrigerant to be distributed by the distributor can be adjusted.

The controller may control the distributor to supply cold to the area where the driver is located through the branch circuit for the excess capacity remaining after the cooling of the battery with respect to the cooling capacity of the refrigerant circuit according to the current temperature information of the battery.

The refrigerant circuit may include a compressor configured to compress the refrigerant, a condenser configured to condense the refrigerant compressed in the compressor, a first expander configured to expand the refrigerant coming from the condenser through the distributor, and a first evaporator configured to evaporate the refrigerant expanded in the first expander; the branch circuit may include a second expander configured to expand the refrigerant distributed from the distributor, and a second evaporator configured to evaporate the refrigerant expanded in the second expander; the refrigerant may be circulated along a first circulation path that sequentially passes through the compressor, the condenser, the distributor, the first expander, and the first evaporator and then returns to the compressor and a second circulation path that sequentially passes through the compressor, the condenser, the distributor, the second expander, and the second evaporator and then returns to the compressor; and the compressor and the condenser may be disposed in a section where the refrigerant moves from the first point to the second point.

The refrigerant circuit may further include a chiller configured to cool the refrigerant condensed in the condenser, and the chiller may be disposed between the condenser and the distributor.

The second evaporator and the evaporation fan may be disposed in a cold air passage having an intake configured such that air is sucked thereinto and outlets configured such that air is discharged therethrough in the area where the driver is located.

The intake may be one in number, and the outlets may be plural in number.

According to a second aspect of the present disclosure, there is provided a cooling system for an electric-powered tractor, the cooling system including: a refrigerant circuit configured to circulate a refrigerant while repeating a process in which compression, condensation, first expansion, and first evaporation are followed by second evaporation; a condensation fan configured to supply air required for the condensation of the refrigerant performed in the refrigerant circuit; a coolant circuit configured to circulate a coolant cooled through heat exchange with the refrigerant in the first evaporation of the coolant performed in the refrigerant circuit, and to cool a battery with the cold of the coolant; and an evaporation fan configured to supply air to be cooled by the second evaporation of the refrigerant performed in the refrigerant circuit, and to supply cooled air to an area where a driver is located.

The refrigerant circuit may include a compressor configured to compress the refrigerant, a condenser configured to condense the refrigerant compressed in the compressor, a first expander configured to expand the refrigerant coming from the condenser, a first evaporator configured to primarily evaporate the refrigerant expanded in the first expander, and a second evaporator configured to secondarily evaporate the refrigerant coming after being primarily evaporated in the first evaporator; and the refrigerant may be circulated along a circular path that sequentially passes through the compressor, the condenser, the first expander, the first evaporator, and the second evaporator and then returns to the compressor.

The refrigerant circuit may further include a second expander configured to expand the refrigerant coming through the first evaporator, and the refrigerant expanded in the second expander may be evaporated in the second evaporator.

The second evaporator and the evaporation fan may be disposed in a cold air passage having an intake configured such that air is sucked thereinto and outlets configured such that air is discharged therethrough in the area where the driver is located.

The intake may be one in number, and the outlets may be plural in number.

The refrigerant circuit may further include a chiller configured to cool the refrigerant condensed in the condenser, and the chiller may be disposed between the condenser and the first evaporator.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a diagram showing the configuration of a cooling system for an electric-powered tractor according to a first embodiment of the present disclosure;

FIG. 2 is a diagram showing the configuration of a cooling system for an electric-powered tractor according to a second embodiment of the present disclosure; and

FIGS. 3 to 5 are reference diagrams illustrating the locations and configurations of a second evaporator and an evaporation fan in each of the cooling systems of FIGS. 1 and 2.

### DETAILED DESCRIPTION

Embodiments of the present disclosure will be described with reference to the accompanying drawings. For brevity of description, descriptions of well-known configurations will be omitted or abridged as much as possible.

### First Embodiment

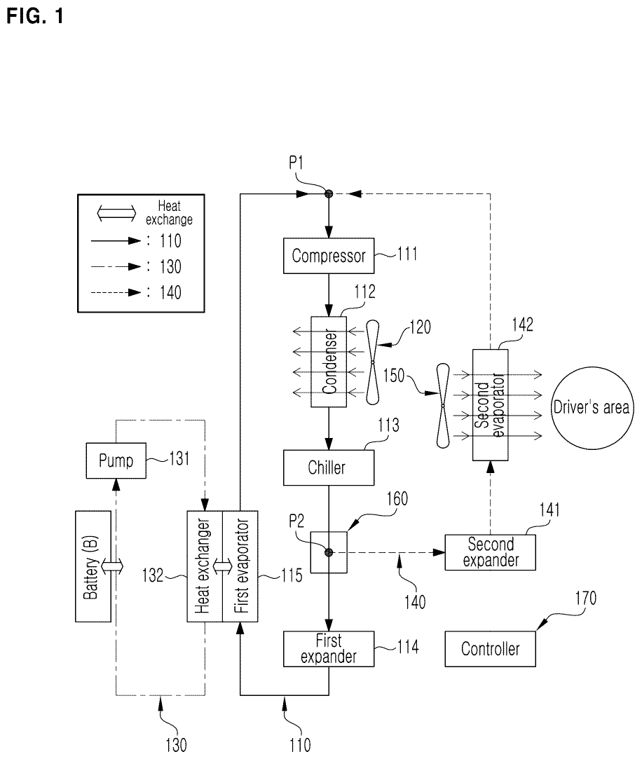

FIG. 1 is a diagram showing the configuration of a cooling system 100 for an electric-powered tractor (hereinafter abbreviated as the “cooling system”) according to a first embodiment of the present disclosure.

The cooling system 100 includes a refrigerant circuit 110, a condensation fan 120, a coolant circuit 130, a branch circuit 140, an evaporation fan 150, a distributor 160, and a controller 170.

The refrigerant circuit 110 circulates a refrigerant by repeating a process including the compression, condensation, expansion, and evaporation of the refrigerant. For this purpose, the refrigerant circuit 110 includes a compressor 111, a condenser 112, a chiller 113, a first expander 114, and a first evaporator 115.

The compressor 111 compresses the evaporated refrigerant in the circulation path of the refrigerant and provides the circulation power required for the circulation movement of the refrigerant.

The compressor 111 may be, e.g., a reciprocating type or a rotary type, and may be provided as a variable capacity type.

The condenser 112 is provided to condense the refrigerant compressed in the compressor 111. The condensation of the refrigerant performed in the condenser 112 is performed in such a manner that the refrigerant, brought to a high-pressure gaseous state by the compressor 111, absorbs cold from an area around the condenser 112 and falls below the condensation temperature.

The chiller 113 is disposed between the condenser 112 and the distributor 160, and further cools the refrigerant coming from the condenser 112. Since the refrigerant is additionally cooled by the chiller 113, the cooling efficiency accomplished by the refrigerant circuit 110 may be further improved. It is obvious that the chiller 113 may be optionally provided depending on the performance level of the compressor 111 and the condenser 112.

The first expander 114 expands the refrigerant entering from the condenser 112 through the chiller 113 and the distributor 160. As the refrigerant expands by the first expander 114, the temperature thereof falls. The first expander 114 may be implemented as, e.g., a capillary tube or an expansion valve.

The first evaporator 115 is provided to evaporate the refrigerant expanded in the first expander 114. That is, the refrigerant that has entered a low-temperature state due to expansion is evaporated in the first evaporator 115 while absorbing heat from the surroundings.

According to the present embodiment, the compression, condensation, and cooling of the refrigerant is performed while the refrigerant moves from a first point P1 upstream of the compressor 111 to a second point P2 downstream of the chiller 113 on the path according to the circulation movement of the refrigerant provided by the refrigerant circuit 110. For this purpose, the compressor 111, the condenser 112, and the chiller 113 are disposed in the section where the refrigerant moves from the first point P1 to the second point P2.

In addition, according to the present embodiment, the expansion and evaporation of the refrigerant is performed while the refrigerant moves from the second point P2 to the first point P1 on the path according to the circulation movement of the refrigerant provided by the refrigerant circuit 110. For this purpose, the first expander 114 and the first evaporator 115 are disposed in the section where the refrigerant moves from the second point P2 to the first point P1.

The condensation fan 120 supplies relatively low-temperature air required for the condensation of the refrigerant so that the refrigerant passing through the condenser 112 is condensed. That is, the refrigerant in a high-temperature, high-pressure gaseous state exchanges heat with air, supplied by the condensation fan 120, through the medium of the condenser 112. In this case, the refrigerant, whose temperature has risen as it is brought to a high-pressure state by the compressor 111, absorbs cold from relatively cold air and undergoes a phase change to be condensed while passing through the condenser 112.

The coolant circuit 130 circulates a coolant that is cooled through heat exchange with the refrigerant evaporated in the refrigerant circuit 110. The coolant is circulated along the path provided by the coolant circuit 130, and cools a battery B with the cold received from the refrigerant circuit 110. For this purpose, the coolant circuit 130 has a pump 131 and a heat exchanger 132.

The pump 131 generates circulation power for the coolant that circulates along the path provided by the coolant circuit 130.

The heat exchanger 132 exchanges heat with the first evaporator 115. The coolant receives cold from the low-temperature refrigerant passing through the first evaporator 115, and sends heat to the refrigerant. Accordingly, the coolant is cooled, and the cooled coolant transfers cold to the battery B, thereby lowering the temperature of the battery B. Furthermore, the refrigerant that absorbs heat from the battery B through the medium of the coolant is evaporated.

The branch circuit 140 branches off from the refrigerant circuit 110 at the second point P2 and then merges with the refrigerant circuit 110 at the first point P1. In the branch circuit 140, the refrigerant expands and evaporates. For this purpose, the branch circuit 140 has a second expander 141 and a second evaporator 142.

The second expander 141 expands the refrigerant coming from the condenser 112 through the chiller 113 and then branching off at the second point P2. As the refrigerant expands by the second expander 141, the temperature thereof falls. The second expander 141 may be implemented as a capillary tube or an expansion valve.

The second evaporator 142 is provided to evaporate the refrigerant that has been expanded in the second expander 141. That is, the refrigerant that has entered a low-temperature state while being expanded by the second expander 141 is evaporated while absorbing heat in the second evaporator 142.

The evaporation fan 150 supplies air to be cooled by the evaporation of the refrigerant performed in the second evaporator 142 of the branch circuit 140. Additionally, the evaporation fan 150 supplies the air, cooled through heat exchange with the refrigerant passing through the second evaporator 142, to the area where a driver is located. That is, the evaporation fan 150 has two functions of supplying air to the second evaporator 142 and supplying air to the area where a driver is located. The arrangement of the evaporation fan 150 and the second evaporator 142 paired with the evaporation fan 150 will be described in more detail later.

The distributor 160 distributes a part of the refrigerant, circulating along the refrigerant circuit 110, to the branch circuit 140.

It is obvious that the distributor 160 is disposed at the second point P2. After the refrigerant has passed through the chiller 113, a part thereof is distributed to the branch circuit 140 in the distributor 160.

However, it is sufficient if the refrigerant distributed to the branch circuit 140 can cool the air by absorbing heat from the air supplied by the evaporation fan 150, so that the second point P2 where the distributor 160 is disposed may vary depending on the implementation.

For example, the distributor 160 may be disposed between the condenser 112 and the chiller 113. In this case, the condensed refrigerant distributed to the branch circuit 140 is expanded in the second expander 141 and then evaporated in the second evaporator 142, thereby cooling the air supplied by the evaporation fan 150.

For example, when the second expander 141 is omitted, the distributor 160 may be disposed between the first expander 114 and the first evaporator 115. In this case, the refrigerant distributed from the distributor 160 to the branch circuit 140 cools the air supplied by the evaporation fan 150 while being evaporated in the second evaporator 142.

For example, when the chiller 113 is omitted, the distributor 160 may be disposed between the condenser 112 and the first evaporator 115.

It may be desirable for the distributor 160 to be provided such that the amount of refrigerant to be distributed to the branch circuit 140 can be adjusted. A further supplementary description will be provided regarding the background of the distributor 160.

The electric-powered tractor needs to be equipped with a cooling system 100 to prevent the overheating of the battery B. The cooling capacity of the cooling system 100 needs to be implemented to lower the battery B to an appropriate temperature at the highest load of the electric-powered tractor.

However, the current load of the electric-powered tractor in operation is mostly lower than the maximum load.

Even when the electric-powered tractor performs high-load work, it has an average load ratio of 60% of the maximum load. Furthermore, the usage time under a high load of 80% or more of the maximum load is only 30% of the tractor usage time.

In particular, in the case of a small electric-powered tractor, many tasks use only partial load. For example, the towing work, loader work, and pest control work of a small trailer are performed at a load ratio of 10 to 60%.

In other words, when the electric-powered tractor is actually used, a design is made to use only a part of the cooling capacity designed for each task in order to cool the battery B. Accordingly, the present embodiment has been contrived to utilize the excess of the cooling capacity (excess capacity) for cooling for a driver. Accordingly, in the present embodiment, in order to utilize the excess capacity, the distributor 160 distributes an amount of refrigerant corresponding to the excess capacity to the branch circuit 140. For this purpose, it may be desirable for the distributor 160 to be implemented to adjust the amount of refrigerant to be distributed to the branch circuit 140.

It is obvious that it may also be easily contemplated that an implementation is made to provide the cooling capacity exceeding the maximum load and distribute an amount of refrigerant corresponding to the excess of the cooling capacity over the maximum load to the branch circuit 140. Even in this case, there is no need to provide a separate compressor 111, condenser 112, and chiller 113 in order to cool the area where a driver is located. Accordingly, in this case, it is easy to design an electric-powered tractor and the manufacturing costs may be reduced due to the omission of parts.

The amount of refrigerant to be distributed by the distributor 160 may be adjusted by the controller 170.

The controller 170 performs the control required for the operation of the cooling system 100. In particular, the controller 170 controls the distributor 160 so that the amount of refrigerant to be distributed to the branch circuit 140 by the distributor 160 can be adjusted.

The controller 170 is preferably implemented to adjust the amount of refrigerant to be distributed according to the current temperature information of the battery B. For this purpose, the electric-powered tractor needs to have a temperature sensor configured to detect the temperature of the battery B. In this case, based on the temperature value of the battery detected by the temperature sensor, the controller 170 controls the distributor 160 so that only refrigerant corresponding to the excess capacity remaining after the cooling of the battery B to an appropriate temperature with respect to the cooling capacity of the refrigerant circuit 110 is distributed to the branch circuit 140 through the distributor 160. Accordingly, only the refrigerant corresponding to the excess capacity may be used to cool the air supplied to the second evaporator 142 of the branch circuit 140 by the evaporation fan 150.

That is, the refrigerant distributed to the branch circuit 140 only as much as the excess capacity transfers cold to the air supplied to the second evaporator 142 by the evaporation fan 150, and absorbs cold from the refrigerant of the second evaporator 142, so that the cooled air is supplied to the area where a driver is located.

For reference, when there is no excess capacity, the distributor 160 may be controlled by the controller 170 to block the branch circuit 140. It is obvious that an implementation may be made to further provide a separate opening/closing means that can selectively open and close the branch circuit 140 while being controlled by the controller 170.

Next, the circulation movement of the refrigerant performed in the cooling system 100 according to the first embodiment will be described.

According to the present embodiment, the refrigerant A moves along a first circulation path that sequentially passes through the compressor 111, the condenser 112, the chiller 113, the distributor 160, the first expander 114, and the first evaporator 115 and returns back to the compressor 111 and a second circulation path that sequentially passes through the compressor 111, the condenser 112, the chiller 113, the distributor 160, the second expander 141, and the second evaporator 142 and returns back to the compressor 111.

First, the first circulation path will be described.

The refrigerant that has passed through the first point P1 is compressed in the compressor 111. Then, the compressed air is condensed in the condenser 112 while absorbing cold from the air supplied by the condensation fan 120.

The condensed refrigerant is cooled once again in the chiller 113, passes through the distributor 160, expands in the first expander 114, and thus enters a low-temperature state. Then, the low-temperature refrigerant absorbs heat from the coolant in the heat exchanger 132 of the coolant circuit 130 and is evaporated while moving through the first evaporator 115. In response to this, the coolant cooled by absorbing cold from the refrigerant transfers cold to the battery B, thereby lowering the temperature of the battery B.

In addition, the refrigerant evaporated while passing through the first evaporator 115 moves back to the compressor 111 through the first point P1.

Next, the second circulation path will be described.

The refrigerant that has passed through the first point P1 is compressed in the compressor 111. Then, the compressed air is condensed in the condenser 112 while absorbing cold from the air supplied by the condensation fan 120.

The condensed refrigerant is cooled once again in the chiller 113, and then a part of the refrigerant corresponding to the excess capacity is distributed to the branch circuit 140 through the distributor 160. The refrigerant distributed to the branch circuit 140 expands in the second expander 141, and enters a low-temperature state. The low-temperature refrigerant absorbs heat from the air supplied by the evaporation fan 150, and is evaporated while passing through the second evaporator 142. In response to this, the air cooled while absorbing cold from the refrigerant is supplied to the area where the driver is located, thereby taking heat away from the driver.

Thereafter, the refrigerant evaporated while passing through the second evaporator 142 is input into the refrigerant circuit 110 through the first point P1, and then moves to the compressor 111.

### Second Embodiment

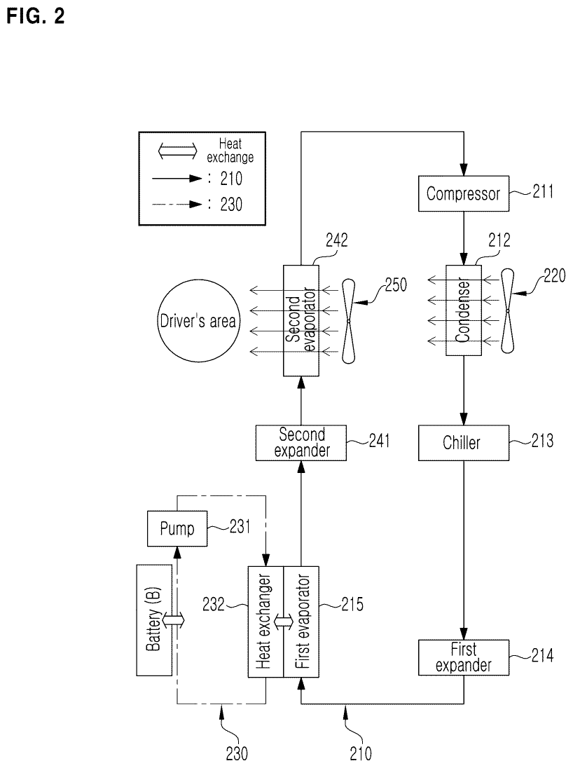

FIG. 2 is a diagram showing the configuration of a cooling system 200 according to a second embodiment of the present disclosure.

The cooling system 200 according to the second embodiment includes a refrigerant circuit 210, a condensation fan 220, a coolant circuit 230, and an evaporation fan 250.

The refrigerant circuit 210 circulates a refrigerant while repeating a process including compression, condensation, first expansion, first evaporation, second expansion, and second evaporation. For this purpose, the refrigerant circuit 210 includes a compressor 211, a condenser 212, a chiller 213, a first expander 214, a first evaporator 215, a second expander 241, and a second evaporator 242.

The compressor 211 compresses the evaporated refrigerant, and provides circulation power required for the circulation movement of the refrigerant.

The condenser 212 is provided to condense the refrigerant compressed in the compressor 211.

The chiller 213 is disposed between the condenser 212 and the first expander 214, and cools the refrigerant coming from the condenser 212.

The first expander 214 primarily expands the refrigerant coming from the condenser 212 through the chiller 213. In the same manner, as the refrigerant expands by the first expander 214, the temperature of the refrigerant falls.

The first evaporator 215 is provided to evaporate the refrigerant expanded in the first expander 214.

The second expander 241 secondarily expands the refrigerant coming through the first evaporator 215. That is, the excess refrigerant that remains condensed while passing through the first expander 214 and the first evaporator 215 is expanded while passing through the second expander 241.

The second evaporator 242 is provided to transfer the cold of the refrigerant having entered a low-temperature state while expanding in the second expander 241 and the excess cold contained in the refrigerant maintaining a lower temperature than the supplied air even while passing through the first evaporator 215 to the air.

The present embodiment has been contrived for the purpose of utilizing the excess cold contained in the refrigerant before the refrigerant having passed through the first evaporator 215 is input to the compressor 211 to cool the area where a driver is located. When this purpose can be satisfied, it may also be easily contemplated that the second expander 241 is omitted. When the second expander 241 is omitted, the refrigerant first sends cold to the coolant in the first evaporator 215, and then sends excess cold to the air in the second evaporator 242.

The condensation fan 220 supplies the air required for the condensing of the refrigerant so that the refrigerant passing through the condenser 212 can be condensed. The air supplied to the condenser 212 by the condensation fan 220 exchanges heat with the refrigerant through the medium of the condenser 212. In this case, the refrigerant whose temperature rises as it is brought to a high-pressure state by the compressor 211 is condensed while absorbing cold from the relatively cold air.

The coolant circuit 230 has a pump 231 and a heat exchanger 232, and is the same as that in the first embodiment, so that a description thereof will be omitted.

The evaporation fan 250 supplies air to be cooled by the evaporation of the refrigerant performed in the second evaporator 242. Furthermore, the evaporation fan 250 supplies the air, cooled through heat exchange with the refrigerant of the second evaporator 242, to the area where a driver is located.

For reference, according to the present embodiment, the evaporation of the refrigerant may not be performed in the second evaporator 242. The reason for this is that all the evaporation of the refrigerant can be performed in the first evaporator 215. However, even when all the evaporation of the refrigerant has been performed in the first evaporator 215 and the temperature of the refrigerant is lower than that of the air in the area where a driver's seat is located, cold may be transferred from the refrigerant to the air, so that the driver can feel cool to that extent. That is, the second evaporator 242 may only function as a heat exchange means for heat exchange between the air supplied by the evaporation fan 250 and the refrigerant.

For reference, although the controller is not shown in FIG. 2 based on the second embodiment, it naturally needs to be provided in the present embodiment as well because the controller is a component for controlling the cooling system 200.

Next, the circulation movement of the refrigerant performed in the cooling system 200 according to the second embodiment will be described.

According to the present embodiment, the refrigerant moves along a circulation path that sequentially passes through the compressor 211, the condenser 212, the chiller 213, the first expander 214, the first evaporator 215, the second expander 241, and the second evaporator 242 and then returns back to the compressor 211.

The refrigerant is compressed in the compressor 211. Then, the compressed air is condensed in the condenser 212 while absorbing cold from the air supplied by the condensation fan 220.

The condensed refrigerant is cooled once again in the chiller 213, and then enters a low-temperature state while expanding in the first expander 214. The low-temperature refrigerant absorbs heat from the coolant passing through the heat exchanger 232 of the coolant circuit 230, and is then evaporated while moving through the first evaporator 215. Accordingly, the coolant that has been cooled by absorbing cold from the refrigerant transfers cold to the battery B, thereby lowering the temperature of the battery B.

The refrigerant evaporated while passing through the first evaporator 215 expands again in the second expander 241, and then sends cold to the air supplied by the evaporation fan 250 while passing through the second evaporator 242. Furthermore, the refrigerant that exits the second evaporator 242 moves back to the compressor 211.

### <Description of Arrangement of Evaporation Fan and Second Evaporator>

The present disclosure has been contrived to supply air at a temperature lower than that of the surrounding air to the area where a driver is located by utilizing a refrigerant that is used to cool a coolant.

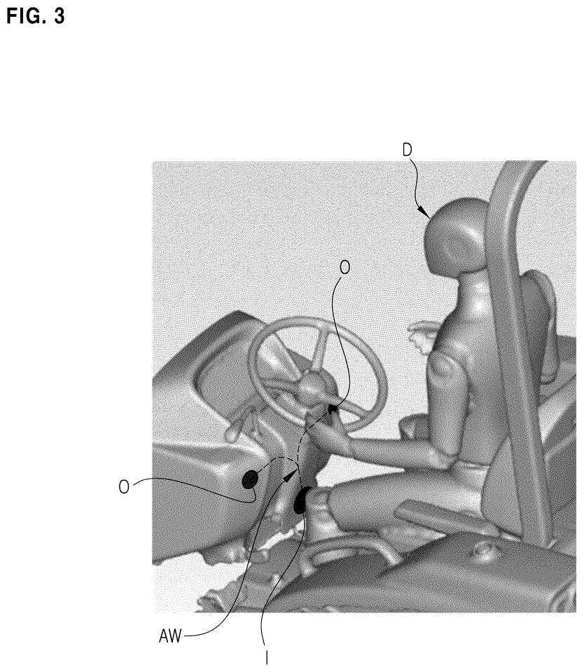

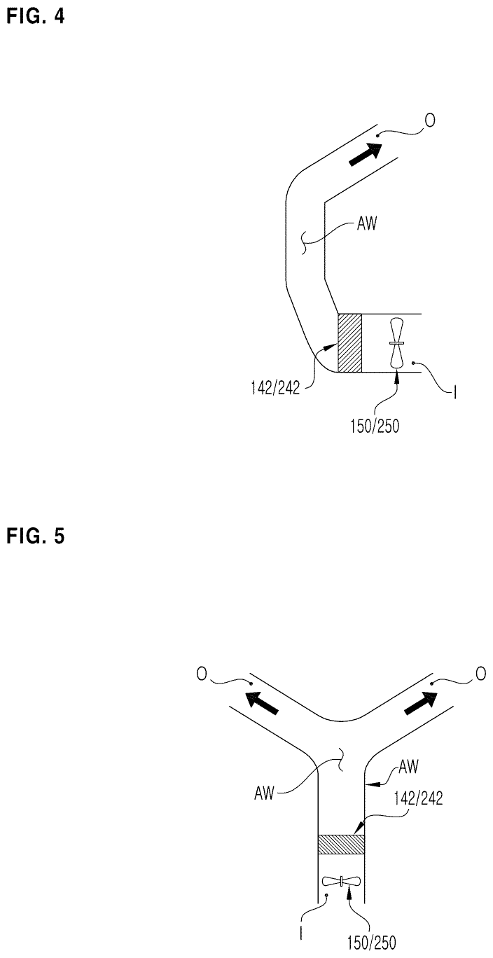

Accordingly, the electric-powered tractor has a cold air passage AW, as shown in the schematic diagram of FIG. 3.

The cold air passage AW has an intake I configured such that air is sucked thereinto and outlets O configured such that air is discharged therethrough.

Relatively high-temperature air is sucked into the intake I, and the air brought to a relatively low-temperature state by being cooled by the second evaporator 142 or 242 is discharged through the outlets O.

As shown in FIGS. 3 and 5, in the cold air passage AW, the two outlets O may be provided to correspond to the one intake port I.

According to an example of the present disclosure, both the intake I and the outlets O are located in the area where the driver is located. Accordingly, it is desirable that the outlets O and the intake I are spaced apart from each other by a predetermined distance so that the air discharged from the outlets O is not directly sucked into the inlet I.

For example, as shown in FIG. 3, the intake port I may be located at a height where the legs of a driver D are located, and the outlets O may be located at a height where the face of the driver D is located.

Naturally, the evaporation fan 150 or 250 and the second evaporator 142 or 242 are disposed in the cold air passage AW.

The evaporation fan 150 or 250 is installed close to the intake I, and the second evaporator 142 or 242 is installed between the outlets O and the evaporation fan 150 or 250. Accordingly, when the evaporation fan 150 or 250 is operated, air is sucked in through the intake I, and the air cooled while passing through the second evaporator 142 or 242 is discharged to the area where the driver D is located through the outlets O.

For reference, when there are two or more outlets O, there is required a structure in which the second evaporator 142 or 242 is disposed before the location where a path is branched into paths toward the plurality of outlets O on the path of air that moves from the inlet I to the outlets O.

### <Additional Description>

1. The present disclosure has been proposed, with the case of use in an electric-powered tractor of 40 horsepower or less without a cabin being taken into consideration. However, even in the case where there is a cabin, it may be contemplated that the cooling system 100 or 200 according to the present disclosure is applied to integrate a cooling system for cooling the battery B and a cooling system for cooling the cabin.

In other words, the present disclosure may be fully applied to any electric-powered tractor regardless of the type thereof.
2. When a field cab is applied to an electric-powered tractor without a cabin, the cooling configuration according to the present disclosure is naturally converted to enable the circulation cooling of the air inside the field cab. Accordingly, an additional advantage arises in that the field cab does not need to have a separate cooling system.
3. According to the above embodiments, the compressor 111 or 211 and the condenser 112 or 212 provided to cool the battery B are provided with the two evaporators 115 and 142, or 215 and 242 in parallel (see the first embodiment) or in series (see the second embodiment). However, depending on the implementation, it may be fully contemplated that an implementation is made such that series and parallel connections can be switched by changing the circuit configuration.

That is, the first and second embodiments may be switched to each other within one cooling system. In this case, in order to provide desirable battery and cabin cooling efficiency according to a current state, the controller 170 needs to be implemented to perform appropriate switching control.

According to the present disclosure, there is no need to separately provide a compressor, a condenser, a chiller, etc. to generate cold air to be supplied to the cabin, so that the following advantages may be achieved:

First, the manufacturing costs can be reduced because there is no need to separately mount a complete cooling system on an electric-powered tractor.

Second, even in a small electric-powered tractor without a cabin, it is possible to generate cold air that can be supplied to a driver by adding a minimal number of parts (an expander, an evaporator, and additional refrigerant piping), so that the driver can work in a relatively comfortable-temperature environment even in hot summer.

Third, an increase in the effectiveness of improving a work environment is higher than an increase in the manufacturing costs, thereby improving the marketability of products to which the present disclosure is applied.

The above-described embodiments are described merely as examples of the present disclosure, and may have various application forms. Accordingly, the present disclosure should not be understood as limited to the content described above. Instead, the scope of rights of the present disclosure should be understood as the range of the attached claims and their equivalents.

What is claimed is:

1. A cooling system for an electric-powered tractor, the cooling system comprising:
a refrigerant circuit configured to circulate a refrigerant while repeating a process in which compression and condensation is performed while the refrigerant moves from a first point to a second point and then expansion and evaporation is performed while the refrigerant moves from the second point to the first point;
a condensation fan configured to supply air required for the condensation of the refrigerant performed in the refrigerant circuit;
a coolant circuit configured to circulate a coolant cooled through heat exchange with the refrigerant evaporated in the refrigerant circuit, and to cool a battery with cold of the coolant;
a branch circuit configured to branch off from the refrigerant circuit at the second point and then merge with the refrigerant circuit at the first point, and configured such that expansion and evaporation of the refrigerant is performed therein;
an evaporation fan configured to supply air to be cooled by the evaporation of the refrigerant performed in the branch circuit, and to supply air, cooled by the branch circuit, to an area where a driver is located; and
a distributor disposed at the second point, and configured to distribute a part of the refrigerant, circulating in the refrigerant circuit, to the branch circuit;
wherein the refrigerant distributed from the refrigerant circuit to the branch circuit at the second point is input to the refrigerant circuit at the first point after expansion and evaporation.

2. The cooling system of claim 1, further comprising a controller configured to control the distributor so that an amount of refrigerant to be distributed by the distributor can be adjusted.

3. The cooling system of claim 1, wherein the controller controls the distributor to supply cold to the area where the driver is located through the branch circuit for excess capacity remaining after the cooling of the battery with respect to cooling capacity of the refrigerant circuit according to current temperature information of the battery.

4. The cooling system of claim 1, wherein:
the refrigerant circuit comprises:
a compressor configured to compress the refrigerant;
a condenser configured to condense the refrigerant compressed in the compressor;
a first expander configured to expand the refrigerant coming from the condenser through the distributor; and
a first evaporator configured to evaporate the refrigerant expanded in the first expander; the branch circuit comprises:
a second expander configured to expand the refrigerant distributed from the distributor; and
a second evaporator configured to evaporate the refrigerant expanded in the second expander;
the refrigerant is circulated along a first circulation path that sequentially passes through the compressor, the condenser, the distributor, the first expander, and the first evaporator and then returns to the compressor and a second circulation path that sequentially passes through the compressor, the condenser, the distributor, the second expander, and the second evaporator and then returns to the compressor; and
the compressor and the condenser are disposed in a section where the refrigerant moves from the first point to the second point.

5. The cooling system of claim 4, wherein:
the refrigerant circuit further comprises a chiller configured to cool the refrigerant condensed in the condenser, and
the chiller is disposed between the condenser and the distributor.

6. The cooling system of claim 4, wherein the second evaporator and the evaporation fan are disposed in a cold air passage having an intake configured such that air is sucked thereinto and outlets configured such that air is discharged therethrough in the area where the driver is located.

7. The cooling system of claim 6, wherein the intake is one in number, and the outlets are plural in number.

8. A cooling system for an electric-powered tractor, the cooling system comprising:
a refrigerant circuit configured to circulate a refrigerant while repeating a process in which compression, condensation, first expansion, and first evaporation are followed by second evaporation;
a condensation fan configured to supply air required for the condensation of the refrigerant performed in the refrigerant circuit;
a coolant circuit configured to circulate a coolant cooled through heat exchange with the refrigerant in the first evaporation of the coolant performed in the refrigerant circuit, and to cool a battery with cold of the coolant; and
an evaporation fan configured to supply air to be cooled by the second evaporation of the refrigerant performed in the refrigerant circuit, and to supply cooled air to an area where a driver is located.

9. The cooling system of claim 8, wherein:
the refrigerant circuit comprises:
a compressor configured to compress the refrigerant;
a condenser configured to condense the refrigerant compressed in the compressor;
a first expander configured to expand the refrigerant coming from the condenser;
a first evaporator configured to primarily evaporate the refrigerant expanded in the first expander; and
a second evaporator configured to secondarily evaporate the refrigerant coming after being primarily evaporated in the first evaporator; and
the refrigerant is circulated along a circular path that sequentially passes through the compressor, the condenser, the first expander, the first evaporator, and the second evaporator and then returns to the compressor.

10. The cooling system of claim 9, wherein:
the refrigerant circuit further comprises a second expander configured to expand the refrigerant coming through the first evaporator; and
the refrigerant expanded in the second expander is evaporated in the second evaporator.

11. The cooling system of claim 9, wherein the second evaporator and the evaporation fan are disposed in a cold air passage having an intake configured such that air is sucked thereinto and outlets configured such that air is discharged therethrough in the area where the driver is located.

12. The cooling system of claim 11, wherein the intake is one in number, and the outlets are plural in number.

13. The cooling system of claim 9, wherein:
the refrigerant circuit further comprises a chiller configured to cool the refrigerant condensed in the condenser, and
the chiller is disposed between the condenser and the first evaporator.
